(19) United States
(12) Patent Application Publication
(10) Pub. No.: US 2016/0028082 A1
(43) Pub. Date: Jan. 28, 2016

(54) Cathode Active Material for Lithium Secondary Battery, and Lithium Secondary Battery Using Same

(71) Applicant: L&F Material Co., Ltd., Gyeongsangbuk-do (KR)

(72) Inventors: Su An Choi, Gyeonggi-do (KR); Sang-Hoon Jeon, Daegu (KR); Su Youn Kwon, Daegu (KR); Jeong A Gu, Daegu (KR); Hyun Chul Jung, Gyeongsangbuk-do (KR); Sung Woo Cho, Gyeongsangnam-do (KR); Bong Jun Jeong, Daegu (KR)

(21) Appl. No.: 14/864,996

(22) Filed: Sep. 25, 2015

Related U.S. Application Data
(63) Continuation-in-part of application No. PCT/KR2013/002503, filed on Mar. 26, 2013.

(51) Int. Cl. H01M 4/36; H01M 10/052; H01M 4/505; H01M 4/38; H01M 4/525; H01M 4/485

(52) U.S. Cl. CPC H01M 4/366; H01M 4/525; H01M 4/485; H01M 4/505; H01M 4/38; H01M 10/052; H01M 2004/028

(57) ABSTRACT

A cathode active material for a rechargeable lithium battery and a rechargeable lithium battery including the same, wherein the cathode active material includes a compound being capable of intercalating and deintercallating lithium, wherein the compound consists of a core part and a coating layer, and the core part is doped with M1 and M2 while the coating layer includes B, are provided.

The M1 and M2 are independently at least one metal selected from Zr, Ti, Mg, Ca, V, Zn, Mo, Ni, Co, and Mn, and M1 and M2 are different.

### CROSS-REFERENCE TO RELATED APPLICATION

This application claims priority to and the benefit of Korean Patent Application No. 10-2014-0035423 filed in the Korean Intellectual Property Office on Mar. 26, 2014, and PCT Application No. PCT/KR2013/002503 filed on Mar. 26, 2013, the entire contents of which are incorporated herein by reference.

### FIELD OF THE INVENTION

A cathode active material for a rechargeable lithium battery and a rechargeable lithium battery including the same are disclosed.

### DESCRIPTION OF THE RELATED ART

In recent times, portable electronic equipment with a reduced size and weight has been increasingly used in accordance with developments in the electronics industry.

In general, batteries generate electrical power using an electrochemical reaction material (hereinafter simply referred to as an “active material”) for a cathode and an anode. Lithium rechargeable batteries generate electrical energy due to chemical potential changes during intercalation/deintercalation of lithium ions at a cathode and an anode.

The lithium rechargeable batteries include a material reversibly intercalating or deintercalating lithium ions during charge and discharge reactions as both cathode and anode active materials, and are filled with an organic electrolyte or a polymer electrolyte between the cathode and anode.

For the cathode active material for a rechargeable lithium battery, lithium composite metal oxide composites such as LiCoO₂, LiMn₂O₄, LiNiO₂, LiMnO₂, and so on have been researched.

Among the cathode active materials, a manganese-based cathode active material such as LiMn₂O₄ and LiMnO₂ is easy to synthesize, costs less than other materials, has excellent thermal stability compared to other active materials, and is environmentally friendly. However, this manganese-based material has relatively low capacity.

LiCoO₂ has good electrical conductivity, a high cell voltage of about 3.7 V, and excellent cycle-life, stability, and discharge capacity, and thus is a presently-commercialized representative material. However, LiCoO₂ is so expensive that it makes up more than 30% of the cost of a battery, and thus may reduce price competitiveness.

In addition, LiNiO₂ has the highest discharge capacity among the above cathode active materials, but is hard to synthesize. Furthermore, nickel therein is highly oxidized and may deteriorate the cycle-life of a battery and an electrode, and thus may have severe deterioration of self discharge and reversibility. Further, it may be difficult to commercialize due to incomplete stability.

In order to improve safety and cycle-life of a battery, JP 2001-530057 discloses a cathode active material for a rechargeable lithium battery, which is substituted with one among Ta, Ti, Nb, Zr, and Hf. In addition, KR 2011-0067545 discloses a cathode active material having excellent charge and discharge cycle durability and improved safety by positioning at least one heterogeneous transition metal selected from a group consisting of Ti and Zr inside and on the surface thereof.

As aforementioned, conventional arts have provided various cathode active materials for a rechargeable lithium battery to improve cycle-life characteristics.

### SUMMARY OF THE INVENTION

One embodiment of the present invention provides a cathode active material for a rechargeable lithium battery having high capacity and excellent cycle-life characteristics, and a rechargeable lithium battery including the cathode active material.

In one embodiment of the present invention, the cathode active material for a rechargeable lithium battery includes a compound being capable of intercalating and deintercallating lithium, the compound consists of a core part and a coating layer, and herein, the core part is doped with M1 and M2, while the coating layer includes B.

The M1 and M2 are independently at least one metal selected from Zr, Ti, Mg, Ca, V, Zn, Mo, Ni, Co, and Mn, and M1 and M2 are different.

The M1 may be Zr or Ti.

The M1 may be Zr, while the M2 may be Ti.

The compound being capable of intercalating and deintercallating lithium may be at least one selected from LiₐA_{1-b}X_{b}D₂ (0.90≦a≦1.8, 0≦b≦0.5); LiₐA_{1-b}X_{b}O_{2-c}T_{c} (0.90≦a≦1.8, 0≦b≦0.5, 0≦c≦0.05); LiE_{1-b}X_{b}O_{2-c}D_{c} (0≦b≦0.5, 0≦c≦0.05); LiE_{2-b}X_{b}O_{4-c}T_{c} (0≦b≦0.5, 0≦c≦0.05); LiₐNi_{1-b-c}Co_{b}X_{c}D_{α} (0.90≦a≦1.8, 0≦b≦0.5, 0≦c≦0.05, 0<α≦2); LiₐNi_{1-b-c}Co_{b}X_{c}O_{2-α}T_{α} (0.90≦a≦1.8, 0≦b≦0.5, 0≦c≦0.05, 0<α<2); LiₐNi_{1-b-c}Co_{b}X_{c}O_{2-α}T₂ (0.90≦a≦1.8, 0≦b≦0.5, 0≦c≦0.05, 0<α<2); LiₐNi_{1-b-c} Mn_{b}X_{c}D_{α} (0.90≦a≦1.8, 0≦b≦0.5, 0≦c≦0.05, 0<α≦2); LiₐNi_{1-b-c}Mn_{b}X_{c}O_{2-α}T_{α}(0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂₋ₑTₑ (0.90≦a≦1.8, 0≦b≦0.9, 0≦c≦0.5, 0.001≦d≦0.1, 0≦e≦0.05); LiₐNi_{b}Co_{c}Mn_{d}GₑO_{2-f}T_{f} (0.90≦a≦1.8, 0≦b≦0.9, 0≦c≦0.5, 0≦d≦0.5, 0.001≦e≦0.1, 0≦e≦0.05); LiₐNiG_{b}O_{2-c}T_{c} (0.90≦a≦1.8, 0.001≦b≦0.1, 0≦c≦0.05); LiₐCoG_{b}O_{2-c}T_{c}(0.90≦a≦1.8, 0.001≦b≦0.1, 0≦c≦0.05); LiₐMnG′_{b}O_{2-c}T_{c} (0.90≦a≦1.8, 0.001≦b≦0.1, 0≦c≦0.05); LiₐMn₂G_{b}O_{2-c}T_{c} (0.90≦a≦1.8, 0.001≦b≦0.1, 0≦c≦0.05); LiₐMnG′_{b}PO₄ (0.90≦a≦1.8, 0.001≦b≦0.1); LiNiVO₄; and Li_{(3-f)}J₂(PO₄)₃ (0≦f≦2).

In the chemical formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

In the cathode active material having a core part doped with M1 and M2 in which the M1 is Zr and M2 is Ti and a coating layer including B, a-axis and c-axis lattice constants may increase, compared with a comparative cathode active material having a core part not doped with the M1 and M2 but with a coating layer including B.

The a-axis lattice constant of the cathode active material having a core part doped with M1 and M2 in which the M1 is Zr and the M2 is Ti, may increase at a higher rate as a Ti/Zr weight ratio increases within a range of greater than about 0 to less than or equal to about 2.0 than that of a cathode active material having a core part doped with the M1 and M2 in which the M1 is Zr and the M2 is Ti, as a Zr/Ti weight ratio increases within a range of greater than about 0 to less than or equal to about 2.0.

The c-axis lattice constant of the cathode active material having a core part doped with M1 and M2 in which the M1 is Zr and the M2 is Ti, may increase at a higher rate as a Zr/Ti weight ratio increases within a range of greater than about 0 to less than or equal to about 2.0 than that of a cathode active material having a core part doped with M1 and M2 in which the M1 is Zr and the M2 is Ti, as a Ti/Zr weight ratio increases within a range of greater than about 0 to less than or equal to about 2.0.

The I(003)/I(104) ratio of the cathode active material having a core part doped with M1 and M2 and a coating layer including B may show an increase rate of less than about 2% than that of a comparative cathode active material having a core part not doped with M1 and M2 and with a coating layer including B.

The M1 and M2 may be independently doped in a mole ratio ranging from about 0.001 to about 0.01.

The B coating layer may have a weight ratio (B/cathode active material) ranging from about 0.02 to about 0.20 wt % based on the total weight of the cathode active material.

In the cathode active material having a core part doped with M1 and M2 in which the M1 is Zr and the M2 is Ti and a coating layer including B, the Zr may be more present than the Ti on the surface.

In another embodiment of the present invention, a rechargeable lithium battery includes: a cathode active material for a rechargeable lithium battery having high capacity and excellent cycle-life characteristics, and a rechargeable lithium battery including the cathode active material.

In one embodiment of the present invention, the cathode active material for a rechargeable lithium battery includes a compound being capable of intercalating and deintercalating lithium, the compound consisting of a core part and a coating layer, wherein the core part is doped with M1 and M2 and the coating layer includes B.

The M1 and M2 are independently at least one metal selected from Zr, Ti, Mg, Ca, V, Zn, Mo, Ni, Co, and Mn, and M1 and M2 are different.

The M1 may be Zr or Ti.

The M1 may be Zr, while the M2 may be Ti. The compound being capable of intercalating and deintercalating lithium may be at least one selected from LiₐA_{1-b}X_{b}D₂ (0.90≦a≦1.8, 0≦b≦0.5); LiₐA_{1-b}X_{b}O_{2-c}T_{c} (0.90≦a≦1.8, 0≦b≦0.5, 0≦c≦0.05); LiE_{1-b}X_{b}O_{2-c}D_{c} (0≦b≦0.5, 0≦c≦0.05); LiE_{2-b}X_{b}O_{4-c}T_{c} (0≦b≦0.5, 0≦c≦0.05); LiₐNi_{1-b-c}Co_{b}X_{c}D_{α} (0.90≦a≦1.8, 0≦b≦0.5, 0≦c≦0.05, 0<α≦2); LiₐNi_{1-b-c}Co_{b}X_{c}O_{2-α}T_{α} (0.90≦a≦1.8, 0≦b≦0.5, 0≦c≦0.05, 0<α<2); LiₐNi_{1-b-c}CO_{b}X_{c}O_{2-α}T₂ (0.90≦a≦1.8, 0≦b≦0.5, 0≦c≦0.05, 0<α<2); LiₐNi_{1-b-c}Mn_{b}X_{c}D_{α} (0.90≦a≦1.8, 0≦b≦0.5, 0≦c≦0.05, 0<α≦2); LiₐNi_{1-b-c}Mn_{b}X_{c}O_{2-α}T_{α} (0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0≦α≦2); LiₐNi_{b}E_{c}G_{d}O₂₋ₑTₑ (0.90≦a≦1.8, 0≦b≦0.9, 0≦c≦0.5, 0.001≦d≦0.1, 0≦e≦0.05); LiₐNi_{b}CO_{c}Mn_{d}GeO_{2-f}T_{f} (0.90≦a≦1.8, 0≦b≦0.9, 0≦c≦0.5, 0≦d≦0.5, 0.001≦e≦0.1, 0≦e≦0.05); LiₐNiG_{b}O_{2-c}T_{c} (0.90≦a≦1.8, 0.001≦b≦0.1, 0≦c≦0.05); LiₐCoG_{b}O_{2-c}T_{c} (0.90≦a≦1.8, 0.001≦b≦0.1, 0≦c≦0.05); LiₐMnG′_{b}O_{2-c}T_{c} (0.90≦a≦1.8, 0.001≦b≦0.1, 0≦c≦0.05); LiₐMn₂G_{b}O_{2-c}T_{c} (0.90≦a≦1.8, 0.001≦b≦0.1, 0≦c≦0.05); LiₐMnG′_{b}PO₄ (0.90≦a≦1.8, 0.001≦b≦0.1); LiNiVO₄; and Li_{(3-f)}J₂(PO₄)₃ (0≦f≦2).

In the chemical formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

In the cathode active material having a core part doped with M1 and M2 in which the M1 is Zr and M2 is Ti and a coating layer including B, a-axis and c-axis lattice constants may increase, compared with a comparative cathode active material having a core part not doped with the M1 and M2 but with a coating layer including B.

The a-axis lattice constant of the cathode active material having a core part doped with M1 and M2 in which the M1 is Zr and the M2 is Ti, may increase at a higher rate as a Ti/Zr weight ratio increases within a range of greater than about 0 to less than or equal to about 2.0 than that of a cathode active material having a core part doped with the M1 and M2 in which the M1 is Zr and the M2 is Ti, as a Zr/Ti weight ratio increases within a range of greater than about 0 to less than or equal to about 2.0.

The c-axis lattice constant of the cathode active material having a core part doped with M1 and M2 in which the M1 is Zr and the M2 is Ti, may increase at a higher rate as a Zr/Ti weight ratio increases within a range of greater than about 0 to less than or equal to about 2.0 than that of a cathode active material having a core part doped with M1 and M2 in which the M1 is Zr and the M2 is Ti, as a Ti/Zr weight ratio increases within a range of greater than about 0 to less than or equal to about 2.0.

The I(003)/I(104) ratio of the cathode active material having a core part doped with M1 and M2 and a coating layer including B may show an increase rate of less than about 2% than that of a comparative cathode active material having a core part not doped with M1 and M2 and with a coating layer including B.

The M1 and M2 may be independently doped in a mole ratio ranging from about 0.001 to about 0.01.

The B coating layer may have a weight ratio (B/cathode active material) ranging from about 0.02 to about 0.20 wt % based on the total weight of the cathode active material.

In the cathode active material having a core part doped with M1 and M2 in which the M1 is Zr and the M2 is Ti and a coating layer including B, the Zr may be more present than the Ti on the surface.

In another embodiment of the present invention, a rechargeable lithium battery includes: a cathode including a cathode active material for a rechargeable lithium battery according to the embodiment of the present invention; an anode including an anode active material; and an electrolyte.

A cathode active material having excellent battery characteristics and a rechargeable lithium battery including the same may be provided.

### BRIEF DESCRIPTION OF THE DRAWINGS

FIG. 1 is a schematic view showing a rechargeable lithium battery.

FIG. 2 shows XPS (X-ray Photoelectron Spectroscopy) results of a cathode active material according to Example 1.

### DETAILED DESCRIPTION OF THE EMBODIMENTS

Exemplary embodiments of the present invention will hereinafter be described in detail. However, these embodiments are only exemplary, and the present invention is not limited thereto.

In one embodiment of the present invention, a cathode active material for a rechargeable lithium battery including a compound being capable of intercalating and deintercallating lithium, wherein the compound consists of a core part and a coating layer, the core part is doped with M1 and M2, and the coating layer includes B, is provided.

The M1 and M2 are independently at least one metal selected from Zr, Ti, Mg, Ca, V, Zn, Mo, Ni, Co, and Mn, and M1 and M2 are different.

The cathode active material may improve battery characteristics of a rechargeable lithium battery. Specifically, one embodiment of the present invention may provide a cathode active material having high initial capacity and improved cycle-life characteristics compared with a conventional cathode active material including a metal compound on the surface.

The M1 may be Zr or Ti, and specifically, may be Zr, while the M2 may be Ti. However, the present invention is not limited thereto.

For example, the compound being capable of intercalating and deintercallating lithium may be at least one selected from LiₐA_{1-b}X_{b}D₂ (0.90≦a≦1.8, 0≦b≦0.5); LiₐA_{1-b}X_{b}O_{2-c}T_{c} (0.90≦a≦1.8, 0≦b≦0.5, 0≦c≦0.05); LiE_{1-b}X_{b}O_{2-c}D_{c} (0≦b≦0.5, 0≦c≦0.05); LiE_{2-b}X_{b}O_{4-c}T_{c} (0≦b≦0.5, 0≦c≦0.05); LiₐNi_{1-b-c}Co_{b}X_{c} D_{α} (0.90≦a≦1.8, 0≦b≦0.5, 0≦c≦0.05, 0≦α≦2); LiₐNi_{1-b-c}Co_{b}X_{c} O_{2-α}T_{α} (0.90≦a≦1.8, 0≦b≦0.5, 0≦c≦0.05, 0<α<2); LiₐNi_{1-b-c}Co_{b}X_{c}O_{2-α}T₂ (0.90≦a≦1.8, 0≦b≦0.5, 0≦c≦0.05, 0<α<2); LiₐNi_{1-b-c}Mn_{b}X_{c} D_{α} (0.90≦a≦1.8, 0≦b≦0.5, 0≦c≦0.05, 0<α≦2); LiₐNi_{1-b-c}Mn_{b}X_{c}O_{2-α}T_{α} (0.90≦a≦1.8, 0≦b≦0.5, 0≦c≦0.05, 0<α<2); LiₐNi_{1-b-c}Mn_{b}X_{c} O_{2-α}T₂ (0.90≦a≦1.8, 0≦b≦0.5, 0≦c≦0.05, 0<α<2); LiₐNi_{b}E_{c}G_{d}O₂₋ₑTₑ (0.90≦a≦1.8, 0≦b≦0.9, 0≦c≦0.5, 0.001≦d≦0.1, 0≦e≦0.05); LiₐNi_{b}Co_{c}Mn_{d}GₑO_{2-f}T_{f} (0.90≦a≦1.8, 0≦b≦0.9, 0≦c≦0.5, 0≦d≦0.5, 0.001≦e≦0.1, 0≦e≦0.05); LiₐNiG_{b}O_{2-c}T_{c} (0.90≦a≦1.8, 0.001≦b≦0.1, 0≦c≦0.05); LiₐCoG_{b}O_{2-c}T_{c} (0.90≦a≦1.8, 0.001≦b≦0.1, 0≦c≦0.05); LiₐMnG′_{b}O_{2-c}T_{c} (0.90≦a≦1.8, 0.001≦b≦0.1, 0≦c≦0.05); LiₐMn₂G_{b}O_{2-c}T_{c} (0.90≦a≦1.8, 0.001≦b≦0.1, 0≦c≦0.05); LiₐMnG′_{b}PO₄ (0.90≦a≦1.8, 0.001≦b≦0.1); LiNiVO₄; and Li_{(3-f)}J₂(PO₄)₃ (0≦f≦2).

In the chemical formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The cathode active material according to one embodiment of the present invention may improve battery characteristics of a rechargeable lithium battery. The improved battery characteristics may be, for example, initial capacity, cycle-life characteristics at room temperature (about 23° C.) and a high temperature (about 45° C.) under high voltage characteristics, and the like.

The M1 and M2 doping may improve cycle-life characteristics and thermal stability of a battery.

The cathode active material having a core part doped with M1 and M2 in which the M1 is Zr and the M2 is Ti shows a-axis and c-axis lattice constant increase characteristics compared with a cathode active material not doped with the M1 and M2.

Specifically, the Ti is substituted in a Me-0 site in a layered structure and becomes more crystalline and thus increases an a-axis lattice constant, and resultantly, may improve cycle-life characteristics of a battery through increased crystallization and stabilization of the layered structure.

In addition, the Zr is substituted in a Li ion site in the layered structure and positioned where a Li ion is released during discharge. Accordingly, the cathode active material may have less stress during expansion and contraction and more stability. In other words, a c-axis lattice constant is increased, and efficiency characteristics and cycle-life characteristics of a battery may be improved.

In a cathode active material doped with Zr or Ti alone as the M1, an I(003)/I(104) ratio, which indicates crystallinity of a layered structure as the amount of the M1 is increased when the M1 is the Zr decreases, and the crystallinity of the layered structure is decreased. The crystalline decrease may bring about a drawback of decreasing initial capacity, even though battery efficiency is increased by improvement of structural stability due to the M1 doped in a Li ion site.

When the M1 is Ti, and the amount of the M1 is increased, an I(003)/I(104) ratio is increased, and cycle-life characteristics are improved due to crystallinity increase and structural stability. These Zr and Ti characteristics may be combined to trade off a crystallinity increase of the Ti with a crystallinity decrease of the Zr and maximize efficiency and cycle-life characteristics of the Zr and cycle-life characteristics of the Ti.

The I(003)/I(104) ratio of the cathode active material having a core doped with M1 and M2 according to one embodiment of the present invention may have an increase rate of less than about 2% compared with that of a comparative cathode active material having a core part not doped with M1 and M2 and with a coating layer including B.

The a-axis lattice constant of the cathode active material having a core doped with M1 and M2 in which the M1 is Zr and the M2 is Ti may have a higher increase rate as a Ti/Zr weight ratio increases within a range from greater than about 0 and less than or equal to about 2.0 than that of a cathode active material doped with M1 and M2 in which the M1 is Zr and the M2 is Ti as a Zr/Ti weight ratio increases within a range from greater than about 0 and less than or equal to about 2.0.

In addition, the c-axis lattice constant of the cathode active material having a core doped with M1 and M2 in which the M1 is Zr and the M2 is Ti may have a higher increase rate as a Zr/Ti weight ratio increases within a range from greater than about 0 and less than or equal to about 2.0 than that of a cathode active material doped with M1 and M2 in which the M1 is Zr and the M2 is Ti as a Ti/Zr weight ratio increases within a range from greater than about 0 and less than or equal to about 2.0.

The reason is that the Zr and the Ti are selectively doped in a layered structure. Specifically, a cathode active material in which a Zr/Ti weight ratio increases shows a higher c-axis lattice constant increase rate than a cathode active material in which a Ti/Zr weight ratio increases, since the Zr having a similar ion radius of about 0.79 Å to a Li ion radius of about 0.76 Å than the Ti having an ion radius of about 0.60 Å is more selectively substituted in a Li ion site and develops a c-axis lattice constant.

In addition, a cathode active material in which a Ti/Zr weight ratio increases shows a higher c-axis lattice constant increase rate than a cathode active material in which a Zr/Ti weight ratio increases, since the Ti is also more selectively substituted in a Me-0 site and develops an a-axis lattice constant.

The M1 and M2 may be independently doped in a mole ratio ranging from 0.001 to 0.01. Alternatively, the M1 and M2 may be doped in a total mole ratio (the number of moles of the M1 and the M2/the total number of moles of all metals capable of intercalating and deintercallating lithium in a compound) in a range of about 0.001 to about 0.01.

When the mole ratio is less than about 0.001, a desired effect may not be obtained, while when the mole ratio is greater than about 0.01, initial capacity may be excessively decreased and efficiency characteristics may be decreased.

Herein, effective firing may be performed at about 800 to about 1050° C. When the firing is performed at less than about 800° C., battery characteristics at room temperature and a high temperature may be sharply deteriorated. In addition, when the firing is performed at greater than about 1050° C., capacity and capacity retention may be sharply deteriorated.

The cathode active material according to one embodiment of the present invention may include a coating layer including B.

The B is known as an excellent ion conductor and is reported as a stable material even in a 4 V level potential section, and thus may reduce the surface area of an active material when coated and suppress reactivity of the active material with an electrolyte. In addition, the B is known to play a role of filling a defect on the surface. On the other hand, initial capacity and efficiency may be improved by a kinetic effect due to improvement of ion conductivity.

In the cathode active material having a core part doped with M1 and M2 in which the M1 is Zr and the M2 is Ti and having a coating layer including B, the Zr may be more present on the surface than the Ti. The doped Zr has a larger ion radius than the Ti and thus may be more present on the surface. The doped Zr is more present on the surface and thus may more suppress a side reaction with an electrolyte solution with the B coating layer on the surface.

The B coating layer may be used in a weight ratio (B/cathode active material) ranging from about 0.02 to about 0.20 wt % based on the total weight of the cathode active material. When the weight ratio is less than about 0.02, the role of the B (suppression of decomposition of an electrolyte solution or destruction of crystal structure of the cathode active material, and ion conductivity) may be reduced, while when the weight ratio is greater than about 0.20, initial capacity and charge and discharge efficiency may be reduced. However, the present invention is not limited thereto.

When a coating material including B of the above compound is fired with the cathode active material, the firing may be effectively performed at about 300 to about 600° C. When the firing temperature is less than about 300° C., reactivity between the coating material and the cathode active material is deteriorated, and the coating material is detached therefrom, reducing a coating effect. In addition, when the firing temperature is greater than about 600° C., the B element is excessively doped, and thus initial capacity and cycle-life characteristics at room temperature and low and high temperatures may be deteriorated.

In another embodiment of the present invention, a rechargeable lithium battery including a cathode, an anode, and an electrolyte is provided, wherein the cathode includes a current collector and a cathode active material layer on the current collector, and herein, the cathode active material layer includes the above cathode active material.

The cathode active material is the same as the aforementioned embodiment of the present invention and may not be illustrated.

The cathode active material layer may include a binder and a conductive material.

The binder improves binding properties of cathode active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is included to improve electrode conductivity. Any electrically conductive material may be used as a conductive material, unless it causes a chemical change. Examples thereof may be carbon-based materials such as natural graphite, artificial graphite, carbon black, acetylene black, ketjen black, carbon fiber, and the like; metal-based materials including a metal powder or a metal fiber of copper, nickel, aluminum, silver, and the like; a conductive polymer such as a polyphenylene derivative; or a mixture thereof.

The anode includes a current collector and an anode active material layer formed on the current collector, and the anode active material layer includes an anode active material.

The anode active material may include a material that reversibly intercalates/deintercalates lithium ions, a lithium metal, a lithium metal alloy, a material being capable of doping and dedoping lithium, or a transition metal oxide.

The material capable of reversibly intercalating/deintercalating lithium ions may include any carbonaceous material, which includes any carbon anode active material generally used for a rechargeable lithium battery. A representative example of carbon material may include crystalline carbon, amorphous carbon, or a mixture thereof. Examples of the crystalline carbon include graphite such as amorphous, sheet-type, flake-type, spherical, or fibrous natural graphite or artificial graphite, and examples of the amorphous carbon include soft carbon or hard carbon, mesophase pitch carbonation products, and fired coke.

Examples of the lithium metal alloy include lithium and a metal selected from Na, K, Rb, Cs, Fr, Be, Mg, Ca, Sr, Si, Sb, Pb, In, Zn, Ba, Ra, Ge, Al, and Sn.

Examples of the material being capable of doping and dedoping lithium may be Si, SiOₓ (0<x<2), a Si—Y alloy (where Y is an element selected from an alkali metal, an alkaline-earth metal, a group 13 element, a group 14 element, a transition metal, a rare earth element, and a combination thereof, and is not Si), Sn, SnO₂, Sn—Y (where Y is an element selected from an alkali metal, an alkaline-earth metal, a group 13 element, a group 14 element, a transition metal, a rare earth element, and a combination thereof, and is not Sn), and the like. At least one of these materials may be mixed with SiO₂. The element Y may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

The transition metal oxide may be vanadium oxide, lithium vanadium oxide, and the like.

The anode active material layer includes a binder, and optionally a conductive material.

The binder improves binding properties of anode active material particles with one another and with a current collector. Examples thereof may be polyvinyl alcohol, carboxylmethyl cellulose, hydroxypropyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is included to improve electrode conductivity. It may include any electrically conductive material unless it causes a chemical change. Examples of the conductive material include carbon-based materials such as natural graphite, artificial graphite, carbon black, acetylene black, ketjen black, carbon fiber, and the like; metal-based materials such as a metal powder, a metal fiber, or the like including copper, nickel, aluminum, silver, and the like; a conductive polymer such as a polyphenylene derivative; or a mixture thereof.

The current collector may be selected from a copper foil, a nickel foil, a stainless steel foil, a titanium foil, a nickel foam, a copper foam, a polymer substrate coated with a conductive metal, or a combination thereof.

The current collector may use Al, but is not limited thereto.

The anode and the cathode may be fabricated by mixing an active material, a conductive material, and a binder in a solvent to prepare an active material composition and coating the composition on a current collector. The electrode manufacturing method is well known, and thus is not described in detail in the present specification. The solvent includes N-methylpyrrolidone and the like, but is not limited thereto.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, an ester-based, an ether-based, a ketone-based, an alcohol-based, or an aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester-based solvent may include methyl acetate, ethyl acetate, n-propyl acetate, dimethyl acetate, methylpropionate, ethylpropionate, γ-butyrolactone, decanolide, valerolactone, mevalonolactone, caprolactone, or the like. Examples of the ether-based solvent include dibutyl ether, tetraglyme, diglyme, dimethoxyethane, 2-methyltetrahydrofuran, tetrahydrofuran, and the like, and examples of the ketone-based solvent include cyclohexanone or the like. Examples of the alcohol-based solvent include ethyl alcohol, isopropyl alcohol, and the like, and examples of the aprotic solvent include nitriles such as R—CN (where R is a C2 to C20 linear, branched, or cyclic hydrocarbon, a double bond, an aromatic ring, or an ether bond), amides such as dimethylformamide, dioxolanes such as 1,3-dioxolane, sulfolanes, or the like.

The non-aqueous organic solvent may be used singularly or in a mixture. When the organic solvent is used in a mixture, the mixture ratio can be controlled in accordance with desirable battery performance.

The carbonate-based solvent is prepared by mixing a cyclic carbonate and a linear carbonate. In this case, the cyclic carbonate may be mixed with the linear carbonate in an appropriate mixing ratio, and for example, they may be mixed in a volume ratio range of about 9:1 to about 1:9 to about 1:1 to about 1:9, but are not limited thereto.

In addition, the non-aqueous organic electrolyte according to one embodiment of the present invention may be further prepared by mixing a carbonate-based solvent with an aromatic hydrocarbon-based solvent. The carbonate-based solvent may be mixed with the aromatic hydrocarbon-based organic solvent in a volume ratio of about 1:1 to 30:1.

The aromatic hydrocarbon-based organic solvent may be an aromatic hydrocarbon-based compound represented by the following Chemical Formula 1.

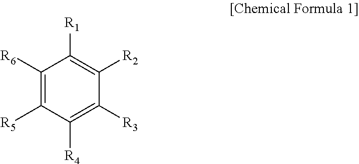

In Chemical Formula 1, R₁ to R₆ are each independently hydrogen, a halogen, a C1 to C10 alkyl group, a haloalkyl group, or a combination thereof.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, and a combination thereof.

The non-aqueous electrolyte may further include an additive of vinylene carbonate, an ethylene carbonate-based compound represented by Chemical Formula 2, or a combination thereof in order to improve cycle-life.

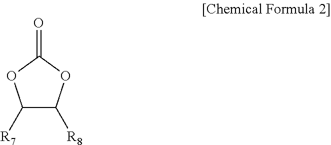

In Chemical Formula 2, R₇ and R₈ are each independently hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group)

Examples of the ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, and fluoroethylene carbonate. The amount of the additive used to improve cycle life may be adjusted within an appropriate range.

The lithium salt supplies lithium ions in the battery, and operates a basic operation of a rechargeable lithium battery and improves lithium ion transport between a cathode and an anode. Examples of the lithium salt include at least one supporting salt selected from LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) where x and y are natural numbers, LiCl, LiI, LiB(C₂O₄)₂ (lithium bis(oxalato) borate; LiBOB), or a combination thereof. The lithium salt may be used at about a 0.1 M to about a 2.0 M concentration. When the lithium salt is included at the above concentration range, an electrolyte may have excellent performance and lithium ion mobility due to optimal electrolyte conductivity and viscosity.

The rechargeable lithium battery may further include a separator between an anode and a cathode, as needed. Examples of suitable separator materials include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

A rechargeable lithium battery may be classified as a lithium ion battery, a lithium ion polymer battery, and a lithium polymer battery according to the presence of a separator and the kind of electrolyte used therein. The rechargeable lithium battery may have a variety of shapes and sizes. In other words, it may include cylindrical, prismatic, coin, or pouch-type batteries and may be a thin film battery or may be rather bulky according to size. Structures and manufacturing methods for lithium ion batteries pertaining to this disclosure are well known in the art.

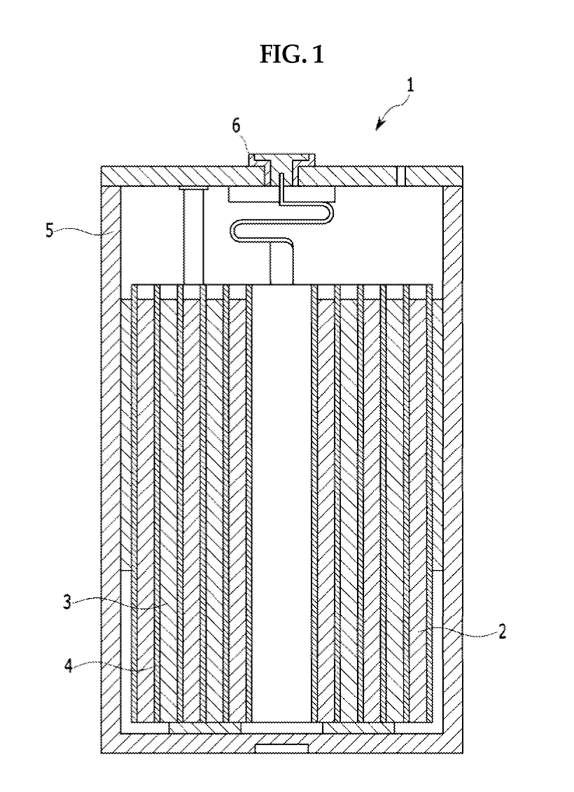

FIG. 1 is a schematic view showing the representative structure of a rechargeable lithium battery. As shown in FIG. 1, the rechargeable lithium battery 1 includes a battery case 5 enclosing a cathode 3, an anode 2, and an electrolyte impregnated in a separator 4 between the cathode 3 and the anode 2, and a sealing member 6 sealing the battery case 5.

Hereinafter, examples of the present invention and comparative examples are described. These examples, however, should not in any sense be interpreted as limiting the scope of the present invention.

### EXAMPLES

### Example 1

An NCM composite transition metal hydroxide (a mole ratio among Ni:Co:Mn=70:15:15) and dispersed ZrO₂ powder and TiO₂ powder were respectively dry-mixed in a weight ratio of 100:0.2:0.3 with a blender, so that the ZrO₂ powder and the TiO₂ powder might be uniformly attached on the surface of the composite transition metal hydroxide particles, and Li₂CO₃ was added thereto based on 1 mol of the composite transition metal hydroxide in a Li/Metal ratio of 1.025 on the surface of which the ZrO₂ powder and the TiO₂ powder were uniformly attached. The dry-mixed powder was heat-treated at 830° C. for 8 h, preparing a lithium composite compound.

The lithium composite compound doped with Zr and Ti were dry-mixed with B₂O₃ in a weight ratio of 100:0.1 to uniformly attach the dispersed B₂O₃ powder on the surface of the lithium composite compound.

The dry-mixed powder was heat-treated at 400° C. for 6 h, preparing a cathode active material.

### Example 2

A cathode active material was prepared according to the same method as Example 1, except for using an NCM composite transition metal hydroxide (a mole ratio among Ni:Co:Mn=60:20:20) and heat-treating the dry-mixed powder at 890° C.

### Example 3

A cathode active material was prepared according to the same method as Example 1, except for adding Li₂CO₃ in an amount of 1.025 mol based on 1 mol of a composite transition metal hydroxide on the surface of which ZrO₂ powder and TiO₂ powder were uniformly attached and dry-mixing LIF with the mixture in a weight ratio of 100:0.1.

### Example 4

Co₃O₄, ZrO₂, powder, and TiO₂ powder were dry-mixed in a weight ratio of 100:0.2:0.3 with a blender, so that the ZrO₂ powder and the TiO₂ powder might be attached on the surface of the Co₃O₄ particles, and Li₂CO₃ was added thereto in a mole ratio of 1.040 mol based on 1 mol of the Co₃O₄ on the surface of which the ZrO₂ powder and the TiO₂ powder were attached.

The dry-mixed powder was heat-treated at 1000° C. for 8 h, preparing a lithium composite compound.

The lithium composite compound doped with Zr and Ti was dry-mixed with B₂O₃ in a weight ratio of 100:0.1 to uniformly attach the dispersed B₂O₃ powder to the surface of the lithium composite compound.

The dry-mixed powder was heat-treated at 400° C. for 6 h, preparing a cathode active material.

### Example 5

A lithium ion cathode active material was prepared according to the same method as Example 1, except for dry-mixing ZrO₂ powder and TiO₂ powder in each weight ratio of 0.2 and 0.1 based on 100 units of the NCM composite transition metal hydroxide.

### Example 6

A lithium ion cathode active material was prepared according to the same method as Example 1, except for dry-mixing ZrO₂ powder and TiO₂ powder in each weight ratio of 0.2 and 0.45 based on 100 units of the NCM composite transition hydroxide.

### Example 7

A lithium ion cathode active material was prepared according to the same method as Example 1, except for dry-mixing ZrO₂ powder and TiO₂ powder in each weight ratio of 0.1 and 0.2 based on 100 units of the NCM composite transition hydroxide.

### Example 8

A lithium ion cathode active material was prepared according to the same method as Example 1, except for dry-mixing ZrO₂ powder and TiO₂ powder in each weight ratio of 0.2 and 0.2 based on 100 units of the NCM composite transition hydroxide.

### Example 9

A lithium ion cathode active material was prepared according to the same method as Example 1, except for dry-mixing ZrO₂ powder and TiO₂ powder in each weight ratio of 0.4 and 0.2 based on 100 units of the NCM composite transition hydroxide.

### Comparative Example 1

Li₂CO₃ in a mole ratio of 1.025 based on 1 mol of an NCM composite transition metalhydroxide (a mole ratio among Ni:Co:Mn=70:15:15) was dry-mixed in a blender.

The dry-mixed powder was heat-treated at 830° C. for 8 h, preparing a cathode active material.

### Comparative Example 2

The cathode active material of Comparative Example 1 and B₂O₃ in a weight ratio of 100:0.1 were dry-mixed so that the dispersed B₂O₃ powder might be uniformly attached to the surface of the cathode active material.

The dry-mixed powder was heat-treated at 400° C. for 6 h, preparing a cathode active material.

### Comparative Example 3

An NCM composite transition metal hydroxide (a mole ratio among Ni:Co:Mn=70:15:15), ZrO₂ powder, and TiO₂ powder were respectively dry-mixed in a weight ratio of 100:0.2:0.3 with a blender to attach the ZrO₂ powder and TiO₂ powder on the surface of the composite transition metal hydroxide particles, and Li₂CO₃ was added thereto and dried therewith in a mole ratio of 1.025 based on 1 mol of the composite transition metal hydroxide on which on the surface of the composite transition metal hydroxide particles, the ZrO₂ powder, and the TiO₂ powder were attached. The dry-mixed powder was heat-treated at 830° C. for 8 h, preparing a cathode active material.

### Comparative Example 4

A cathode active material was prepared according to the same method as Comparative Example 3, except for using an NCM composite transition metal hydroxide (a mole ratio among Ni:Co:Mn=60:20:20) and performing heat treatment at 890° C.

### Comparative Example 5

Co₃O₄, ZrO₂ powder, and TiO₂ powder were mixed in each weight ratio of 100:0.2:0.3 with a blender, so that the ZrO₂ powder and the TiO₂ powder might be uniformly attached on the surface of the Co₃O₄ particles, and Li₂CO₃ was added thereto and mixed therewith in a mole ratio of 1.040 based on 1 mol of the Co₃O₄ of which on the surface the ZrO₂ powder and the TiO₂ powder were uniformly attached.

The dry-mixed powder was heat-treated at 1000° C. for 8 h, preparing a cathode active material.

### Comparative Example 6

A lithium ion cathode active material was prepared according to the same method as Example 1, except for using ZrO₂ powder in a weight ratio of 0.2 based on 100 units of an NCM composite transition hydroxide.

### Comparative Example 7

A lithium ion cathode active material was prepared according to the same method as Example 1, except for using ZrO₂ powder in a mole ratio of 0.4 based on 100 units of an NCM composite transition hydroxide.

### Comparative Example 8

A lithium ion cathode active material was prepared according to the same method as Comparative Example 3, except for using ZrO₂ powder in a weight ratio of 0.2 based on 100 units of an NCM composite transition hydroxide.

### Comparative Example 9

A lithium ion cathode active material was prepared according to the same method as Comparative Example 3, except for using ZrO₂ powder in a weight ratio of 0.4 based on 100 units of an NCM composite transition hydroxide.

### Comparative Example 10

A lithium ion cathode active material was prepared according to the same method as Comparative Example 3, except for dry-mixing ZrO₂ powder in a weight ratio of 0.2 based on 100 units of an NCM composite transition hydroxide.

### Comparative Example 11

A lithium ion cathode active material was prepared according to the same method as Example 1, except for dry-mixing TiO₂ powder in a weight ratio of 0.25 based on 100 units of an NCM composite transition hydroxide.

### Comparative Example 12

A lithium ion cathode active material was prepared according to the same method as Example 1, except for dry-mixing TiO₂ powder in a weight ratio of 0.5 based on 100 units of an NCM composite transition hydroxide.

### Comparative Example 13

A lithium ion cathode active material was prepared according to the same method as Comparative Example 3, except for dry-mixing TiO₂ powder in a weight ratio of 0.25 based on 100 units of an NCM composite transition hydroxide.

### Comparative Example 14

A lithium ion cathode active material was prepared according to the same method as Comparative Example 3, except for dry-mixing TiO₂ powder in a weight ratio of 0.5 based on 100 units of an NCM composite transition hydroxide.

### Comparative Example 15

A lithium ion cathode active material was prepared according to the same method as Comparative Example 3, except for dry-mixing TiO₂ powder in a weight ratio of 0.7 based on 100 units of an NCM composite transition hydroxide.

### Manufacture of Coin Cell

95 wt % of each cathode active material according to the examples and comparative examples was added to 2.5 wt % of carbon black as a conductive agent, 2.5 wt % of PVDF as a binder, and 5.0 wt % of N-methyl-2-pyrrolidone (NMP) as a solvent, preparing a cathode slurry. The cathode slurry was coated on a 20 to 40 μm-thick aluminum (Al) thin film as a cathode current collector, vacuum-dried, and roll pressed, manufacturing a cathode.

As for an anode, a Li-metal was used. The cathode, the Li-metal as a counter electrode, and a 1.15 M LiPF6 solution including EC:DMC (1:1 vol %) as an electrolyte solution were used to manufacture a coin cell type half-cell.

### Experimental Example 1

### Evaluation of Battery Characteristics

Tables 1 and 2 provide the 4.5 V initial formation, rate capability, capacity at the 1^{st} cycle, 20^{th} cycle, and 30^{th} and cycle-life characteristics data of the cells according to the examples and comparative examples.

TABLE 1

| | | | | | | | Rate |
|---|---|---|---|---|---|---|---|
| Cathode | | | | | Discharge | | capability |
| active | Composition | Ti/Zr | | | capacity | | (1.0/0.1 C, |
| material | (Ni:Co:Mn) | (ppm) | B | F | (mAh/g) | Efficiency | %) |
| Example 1 | 70:15:15 | 500/1200 | 350 | — | 212.94 | 0.54 | 91.16 |
| Example 2 | 60:20:20 | 500/1200 | 350 | — | 202.71 | 1.21 | 92.10 |
| Example 3 | 70:15:15 | 1500/1200 | 350 | 500 | 212.74 | 0.58 | 91.21 |
| Example 4 | 0:100:0 | 1500/1200 | 350 | — | 180.71 | 96.14 | 93.04 |
| Comparative | 70:15:15 | —/— | — | — | 210.40 | 89.65 | 90.42 |
| Example 1 | | | | | | | |
| Comparative | 70:15:15 | —/— | 350 | — | 212.69 | 89.74 | 91.06 |
| Example 2 | | | | | | | |
| Comparative | 70:15:15 | 1500/1200 | — | — | 207.98 | 89.76 | 90.49 |
| Example 3 | | | | | | | |
| Comparative | 60:20:20 | 1500/1200 | — | — | 199.82 | 90.60 | 91.50 |
| Example 4 | | | | | | | |
| Comparative | 0:100:0 | 1500/1200 | — | — | 178.79 | 95.89 | 92.64 |
| Example 5 | | | | | | | |
| Comparative | 70:15:15 | —/1200 | 350 | — | 212.67 | 90.21 | 91.23 |
| Example 6 | | | | | | | |
| Comparative | 70:15:15 | —/2700 | 350 | — | 212.37 | 90.24 | 91.31 |
| Example 7 | | | | | | | |
| Comparative | 70:15:15 | —/1200 | — | — | 209.18 | 89.71 | 90.49 |
| Example 8 | | | | | | | |
| Comparative | 70:15:15 | —/2700 | — | — | 208.36 | 89.81 | 90.52 |
| Example 9 | | | | | | | |
| Comparative | 70:15:15 | —/3600 | — | — | 206.89 | 89.83 | 90.53 |
| Example 10 | | | | | | | |
| Comparative | 70:15:15 | 1200/— | 350 | — | 212.91 | 89.61 | 91.18 |
| Example 11 | | | | | | | |
| Comparative | 70:15:15 | 2700/— | 350 | — | 212.88 | 89.59 | 91.17 |
| Example 12 | | | | | | | |
| Comparative | 70:15:15 | 1200/— | — | — | 209.46 | 89.51 | 90.45 |
| Example 13 | | | | | | | |
| Comparative | 70:15:15 | 2700/— | — | — | 208.86 | 89.52 | 90.43 |
| Example 14 | | | | | | | |
| Comparative | 70:15:15 | 3600/— | — | — | 207.71 | 89.48 | 90.44 |
| Example 15 | | | | | | | |

TABLE 2

| | | | | | | | | Cycle- | Cycle- |
|---|---|---|---|---|---|---|---|---|---|
| | | | | | | | | life | life |
| Cathode | | | | | | | | characteristics | characteristics |
| active | Composition | Ti/Zr | | | | | | (20CY/ | (30CY/ |
| material | (Ni:Co:Mn) | (ppm) | B | F | 1CY | 20CY | 30CY | 1CY, %) | 1CY, %) |
| Example 1 | 70:15:15 | 1500/1200 | 350 | — | 208.96 | 184.62 | 170.10 | 88.35 | 81.40 |
| Example 2 | 60:20:20 | 1500/1200 | 350 | — | 199.75 | 176.62 | 162.87 | 88.42 | 81.54 |
| Example 3 | 70:15:15 | 1500/1200 | 350 | 500 | 208.84 | 184.72 | 170.08 | 88.45 | 81.44 |
| Example 4 | 0:100:0 | 1500/1200 | 350 | — | 167.77 | 163.16 | 160.01 | 97.25 | 95.37 |
| Comparative | 70:15:15 | —/— | — | — | 206.60 | 178.01 | 150.67 | 86.16 | 72.93 |
| Example 1 | | | | | | | | | |
| Comparative | 70:15:15 | —/— | 350 | — | 208.57 | 179.89 | 152.34 | 86.25 | 73.04 |
| Example 2 | | | | | | | | | |
| Comparative | 70:15:15 | 1500/1200 | — | — | 205.22 | 181.51 | 167.13 | 88.45 | 81.44 |
| Example 3 | | | | | | | | | |
| Comparative | 60:20:20 | 1500/1200 | — | — | 196.14 | 173.91 | 159.88 | 88.67 | 81.51 |
| Example 4 | | | | | | | | | |
| Comparative | 0:100:0 | 1500/1200 | — | — | 165.75 | 161.27 | 158.00 | 97.30 | 95.32 |
| Example 5 | | | | | | | | | |
| Comparative | 70:15:15 | —/1200 | 350 | — | 208.76 | 181.11 | 160.38 | 86.76 | 76.83 |
| Example 6 | | | | | | | | | |
| Comparative | 70:15:15 | —/2700 | 350 | — | 208.61 | 180.89 | 160.01 | 86.71 | 76.70 |
| Example 7 | | | | | | | | | |
| Comparative | 70:15:15 | —/1200 | — | — | 206.58 | 179.45 | 158.34 | 86.87 | 76.65 |
| Example 8 | | | | | | | | | |
| Comparative | 70:15:15 | —/2700 | — | — | 206.12 | 178.91 | 158.21 | 86.80 | 76.76 |
| Example 9 | | | | | | | | | |
| Comparative | 70:15:15 | —/3600 | — | — | 204.88 | 177.17 | 155.21 | 86.48 | 75.76 |
| Example 10 | | | | | | | | | |
| Comparative | 70:15:15 | 1200/— | 350 | — | 209.11 | 181.58 | 163.25 | 86.83 | 78.07 |
| Example 11 | | | | | | | | | |
| Comparative | 70:15:15 | 2700/— | 350 | — | 209.01 | 181.31 | 163.11 | 86.75 | 78.04 |
| Example 12 | | | | | | | | | |
| Comparative | 70:15:15 | 1200/— | — | — | 206.32 | 179.19 | 161.10 | 86.85 | 78.08 |
| Example 13 | | | | | | | | | |
| Comparative | 70:15:15 | 2700/— | — | — | 206.34 | 179.11 | 161.13 | 86.60 | 78.09 |
| Example 14 | | | | | | | | | |
| Comparative | 70:15:15 | 3600/— | — | — | 204.89 | 177.19 | 158.35 | 86.48 | 77.29 |
| Example 15 | | | | | | | | | |

Referring to Tables 1 and 2, Comparative Examples 8 to 10 in which Zr was doped alone showed excellent cycle-life characteristics compared with Comparative Example 1 in which Zr was not doped.

More specifically, when the amount of Zr was increased in Comparative Examples 8 to 10, efficiency was increased, but initial capacity was decreased. The reason is that the Zr was expected to be substituted in a Li ion site in a layered structure, and as the amount of Zr was increased, structural stability was increased, and thus excellent efficiency was obtained, and in addition, the Li ion sites were decreased and the capacity was decreased.

In Tables 1 and 2, Comparative Examples 13 to 15 in which Ti was doped alone showed excellent battery characteristics compared with Comparative Example 1 in which Ti was not doped. However, a cathode active material doped with Zr or Ti alone showed deteriorated battery characteristics compared with a cathode active material simultaneously doped with Zr and Ti according to Comparative Example 3.

As shown in Tables 1 and 2, the cathode active material doped with Zr and Ti according to Comparative Example 3 showed excellent cycle-life characteristics compared with the cathode active material not doped with Zr and Ti according to Comparative Example 1. However, the cathode active material doped with Zr and Ti had a drawback of deteriorating initial capacity. In order to overcome this capacity deterioration, the cathode active materials including a coating layer including B known as an excellent ion conductor on the surface according to Examples 1, 2, and 4 showed no deterioration compared with the cathode active materials not coated with B according to Comparative Examples 3 to 5. In addition, Examples 1, 2, and 4 showed excellent rate capability by coating B compared with Comparative Examples 3 to 5 in which B was not coated, as shown in Table 1.

In addition, characteristics of B known as an ion conductor were confirmed, since Comparative Example 2 showed excellent initial capacity and rate capability in Comparative Examples 1 and 2 in which Zr and Ti were not doped.

In addition, Example 1 in which Zr and Ti were simultaneously doped and B was coated showed excellent cycle-life characteristics and further had excellent long cycle-life characteristics compared with Comparative Examples 6, 7, 11, and 12 in which Zr or Ti was doped alone and B was coated, as shown in Table 2.

Accordingly, the cathode active materials in which Zr and Ti were doped and B was coated according to Examples 1 to 4 showed excellent battery characteristics, as shown in Tables 1 to 2.

### Experimental Example 2

### Lattice Constant Measurement Through XRD Analysis

The lattice constants of the cathode active materials according to the examples and comparative examples were measured in an X-ray diffraction method (UltimaIV, Rigaku Co.) at room temperature of 25° C. with CuKα, a voltage of 40 kV, a current of 3 mA, 10-90 deg, a step width of 0.01 deg, and a step scan.

TABLE 3

| | Comparative | Comparative | | | |
|---|---|---|---|---|---|
| | Example 2 | Example 6 | Example 5 | Example 1 | Example 6 |
| Ti/Zr | — | —/1200 | 600/1200 | 1500/1200 | 2400/1200 |
| a-axis | 2.8707 | 2.871 | 2.8715 | 2.8722 | 2.8726 |
| lattice | | | | | |
| constant | | | | | |
| | Comparative | Comparative | | | |
| | Example 2 | Example 11 | Example 7 | Example 8 | Example 9 |
| Zr/Ti | — | —/1200 | 600/1200 | 1500/1200 | 2400/1200 |
| a-axis | 2.8707 | 2.8712 | 2.8712 | 2.8718 | 2.8716 |
| lattice | | | | | |
| constant | | | | | |

TABLE 4

| | Comparative | Comparative | | | |
|---|---|---|---|---|---|
| | Example 2 | Example 6 | Example 5 | Example 1 | Example 6 |
| Ti/Zr | — | —/1200 | 600/1200 | 1500/1200 | 2400/1200 |
| c-axis | 14.206 | 14.210 | 14.209 | 14.211 | 14.212 |
| lattice | | | | | |
| constant | | | | | |
| | Comparative | Comparative | | | |
| | Example 2 | Example 11 | Example 7 | Example 8 | Example 9 |
| Zr/Ti | — | —/1200 | 600/1200 | 1500/1200 | 2400/1200 |
| c-axis | 14.206 | 14.208 | 14.210 | 14.215 | 14.218 |
| lattice | | | | | |
| constant | | | | | |

Referring to Tables 3 and 4, a lattice constant turned out to be changed depending on an amount ratio of a doped metal. When the doped metal was Zr and Ti, the lattice constant at an a axis was more increased when a Ti/Zr ratio was increased than when a Zr/Ti ratio was increased, and a lattice constant at a c axis was more increased when a Zr/Ti ratio was increased when a Ti/Zr ratio was increased.

TABLE 5

| | Comparative | Comparative | | | |
|---|---|---|---|---|---|
| | Example 2 | Example 6 | Example 5 | Example 1 | Example 6 |
| Ti/Zr | — | —/1200 | 600/1200 | 1500/1200 | 2400/1200 |
| I(003)/ | 1.546 | 1.510 | 1.545 | 1.548 | 1.549 |
| I(104) | | | | | |
| ratio | | | | | |

Table 5 shows a I(003)/I(104) ratio through the XRD analysis. In the cathode active materials of Comparative Examples 2 and 6, the I(003)/I(104) ratio was decreased, since Zr was doped. The decreased ratio may be used to predict a degree that Zr ions were substituted in a Li ion site. In Examples 1, 5, and 6, Zr and Ti were simultaneously doped and traded off the decreased ratio due to the Zr.

As shown in Tables 1 and 2, a cathode active material in which Zr and Ti were not alone but were simultaneously doped, and with a coating layer including B, realized excellent battery characteristics.

### Experimental Example 3

### XPS Measurement

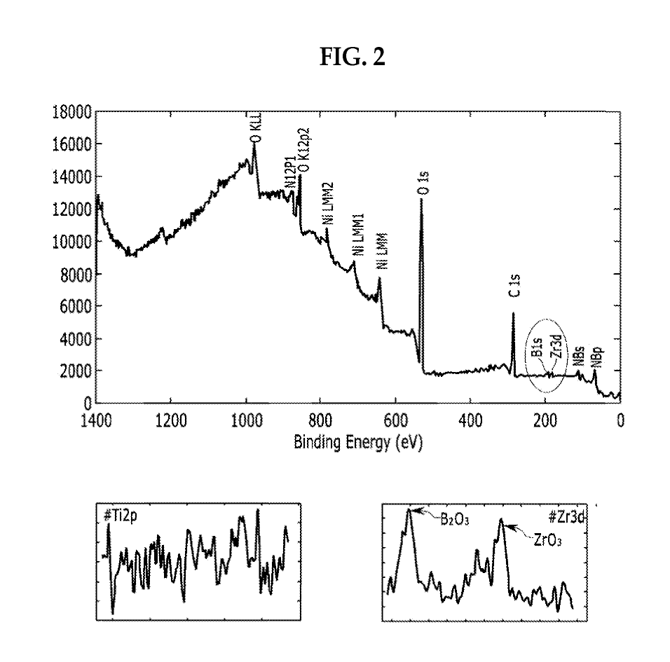

XPS (X-ray Photoelectron Spectroscopy) of the cathode active material according to Example 1 was performed, and the results are provided in FIG. 2. Referring to FIG. 2, B and Zr among doping metals were included on the surface of the cathode active material.

In addition, the Zr was more doped than Ti on the surface, as seen in FIG. 2.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

1. A cathode active material for a rechargeable lithium battery, comprising:
a compound being capable of intercalating and deintercallating lithium, wherein
the compound consists of a core part and a coating layer,
the core part is doped with M1 and M2,
the coating layer comprises B, and
M1 and M2 are independently at least one metal selected from the group consisting of Zr, Ti, Mg, Ca, V, Zn, Mo, Ni, Co, and Mn, and M1 and M2 are different.

2. The cathode active material of claim 1, wherein M1 is Zr or Ti.

3. The cathode active material of claim 1, wherein M1 is Zr and M2 is Ti.

4. The cathode active material for a rechargeable lithium battery of claim 1, wherein the compound being capable of intercalating and deintercallating lithium is at least one selected from the group consisting of LiₐA_{1-b}X_{b}D₂ (0.90≦a≦1.8, 0≦b≦0.5); LiₐA_{1-b}X_{b}O_{2-c}T_{c} (0.90≦a≦1.8, 0≦b≦0.5, 0≦c≦0.05); LiE_{1-b}X_{b}O_{2-c}D_{c} (0≦b≦0.5, 0≦c≦0.05); LiE_{2-b}X_{b}O_{4-c}T_{c} (0≦b≦0.5, 0≦c≦0.05); LiₐNi_{1-b-c}Co_{b}X_{c}D_{α} (0.90≦a≦1.8, 0≦b≦0.5, 0≦c≦0.05, 0<α≦2); LiₐNi_{1-b-c}Co_{b}X_{c}O_{2-α}T_{α} (0.90≦a≦1.8, 0≦b≦0.5, 0≦c≦0.05, 0<α<2); LiₐNi_{1-b-c}Co_{b}X_{c}O_{2-α}T₂ (0.90≦a≦1.8, 0≦b≦0.5, 0≦c≦0.05, 0<α<2); LiₐNi_{1-b-c} Mn_{b}X_{c}D_{α} (0.90≦a≦1.8, 0≦b≦0.5, 0≦c≦0.05, 0<α≦2); LiₐNi_{1-b-c}Mn_{b}X_{c}O_{2-α}T_{α}(0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂₋ₑTₑ (0.90≦a≦1.8, 0≦b≦0.9, 0≦c≦0.5, 0.001≦d≦0.1, 0≦e≦0.05); LiₐNi_{b}Co_{c}Mn_{d}GₑO_{2-f}T_{f} (0.90≦a≦1.8, 0≦b≦0.9, 0≦c≦0.5, 0≦d≦0.5, 0.001≦e≦0.1, 0≦e≦0.05); LiₐNiG_{b}O_{2-c}T_{c} (0.90≦a≦1.8, 0.001≦b≦0.1, 0≦c≦0.05); LiₐCoG_{b}O_{2-c}T_{c}(0.90≦a≦1.8, 0.001≦b≦0.1, 0≦c≦0.05); LiₐMnG′_{b}O_{2-c}T_{c} (0.90≦a≦1.8, 0.001≦b≦0.1, 0≦c≦0.05); LiₐMn₂G_{b}O_{2-c}T_{c} (0.90≦a≦1.8, 0.001≦b≦0.1, 0≦c≦0.05); LiₐMnG′_{b}PO₄ (0.90≦a≦1.8, 0.001≦b≦0.1); LiNiVO₄; and Li_{(3-f)}J₂(PO₄)₃ (0≦f≦2):
wherein, in the chemical formulae, A is selected from the group consisting of Ni, Co, Mn, and a combination thereof; X is selected from the group consisting of Al, Ni, Co, Mn, Cr, Fe, Mg, Sr, V, a rare earth element, and a combination thereof; D is selected from the group consisting of O, F, S, P, and a combination thereof; E is selected from the group consisting of Co, Mn, and a combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

5. The cathode active material of claim 3, wherein the core part is doped with M1 and M2, M1 is Zr and M2 is Ti, and lattice constants at an a-axis and a c-axis are increased compared with a comparative cathode active material in which a core part is not doped with M1 and M2 and which has a coating layer comprising B.

6. The cathode active material of claim 3, wherein the a-axis lattice constant of the cathode active material having a core doped with M1 and M2 in which M1 is Zr and M2 is Ti increases at a higher rate as a Ti/Zr weight ratio increases within a range of greater than about 0 to less than or equal to about 2.0 than that of a cathode active material having a core doped with M1 and M2 in which M1 is Zr and M2 is Ti as a Zr/Ti weight ratio increases within a range of greater than about 0 to less than or equal to about 2.0.

7. The cathode active material of claim 3, wherein the c-axis lattice constant of the cathode active material having a core doped with M1 and M2 in which M1 is Zr and M2 is Ti increases at a higher rate as a Zr/Ti weight ratio increases within a range of greater than about 0 to less than or equal to about 2.0 than that of a cathode active material having a core doped with M1 and M2 in which M1 is Zr and M2 is Ti as a Ti/Zr weight ratio increases within a range of greater than about 0 to less than or equal to about 2.0.

8. The cathode active material of claim 1, wherein a I(003)/I(104) ratio of the cathode active material having a core doped with M1 and M2 in which M1 is Zr and M2 is Ti shows an increase rate of less than about 2% compared with a comparative cathode active material not doped with M1 and M2 but having a coating layer including B.

9. The cathode active material of claim 1, wherein M1 and M2 are independently doped in a mole ratio in a range of about 0.001 to about 0.01.

10. The cathode active material of claim 1, wherein the B coating layer has a weight ratio (B/cathode active material) in a range of about 0.02 to about 0.20 wt % based on the total weight of the cathode active material.

11. The cathode active material, wherein Zr is partially present among the doping metals on the surface of the cathode active material having a core part doped with M1 and M2 in which M1 is Zr and M2 is Ti and a coating layer comprising B.

12. The cathode active material of claim 1, wherein Zr is more present than Ti on the surface of the cathode active material having a core part doped with M1 and M2 in which M1 is Zr and M2 is Ti and a coating layer comprising B.

13. A rechargeable lithium battery comprising:
the cathode including a cathode active material of claim 1;
an anode including an anode active material; and
an electrolyte.
